(19) United States
(12) Patent Application Publication
(10) Pub. No.: US 2012/0300321 A1
(43) Pub. Date: Nov. 29, 2012

(54) Lens Unit with a Temperature Compensation Function

(75) Inventor: Keisuke KURYO, Sakai-shi (JP)

(73) Assignee: Konica Minolta Opto, Inc., Tokyo (JP)

(21) Appl. No.: 13/478,898

(22) Filed: May 23, 2012

(30) Foreign Application Priority Data
May 23, 2011 (JP) 2011-114593

(51) Int. Cl. G02B 7/02

(52) U.S. Cl. 359/820

(57) ABSTRACT

A high-expansion compensating member and a low-expansion compensating member respectively have contact surfaces that make contact with each other in a state inclined with respect to the optical axis such that, when a variation in temperature causes the high-expansion compensating member to expand or contract in the direction perpendicular to the optical axis, the low-expansion compensating member is displaced in the optical axis direction. As the low-expansion compensating member is displaced in the optical axis direction, a compensator lens holding frame and a compensator lens move in the optical axis direction, and thereby a displacement in focal position occurring in an image-taking lens due to a variation in temperature is compensated for.

This application is based on Japanese Patent Application No. 2011-114593 filed on May 23, 2011, the contents of which are hereby incorporated by reference.

### BACKGROUND OF THE INVENTION

1. Field of the Invention

The present invention relates to a lens unit with a temperature compensation function, and more particularly to, for example, a lens unit provided with a lens system such as a projection lens or an image-taking lens and having a function of temperature-compensating the focal position of the lens system.

2. Description of Related Art

In a projection lens or an image-taking lens formed of optical glass with ordinary dispersion, refractive indices vary with the ambient temperature, and accordingly the focal position moves, inconveniently resulting in a degradation in imaging performance. In cases where optical glass such as anomalous dispersion glass or fluorite is used, the focal position moves greatly, resulting in a notable degradation in performance. The problem is, therefore, how to prevent a degradation in imaging performance with a simple, compact design.

As solutions to the above problem, Patent Documents 1 and 2 listed below propose lens units with a temperature compensation function. In the lens system disclosed in Patent Document 1, a compensating block with a high linear expansion coefficient is inserted between a compensator lens holding frame and a housing so as to compensate for a displacement in focal position resulting from a variation in ambient temperature. In the lens unit disclosed in Patent Document 2, a lens system is divided into two lens units, which are supported on a body lens barrel with a different linear expansion coefficient so that a displacement in focal position occurring in the lens system due to a variation in temperature is compensated for with a variation in the distance between the lens units.

Patent Document 1: JP-A-H11-337798

Patent Document 2: JP-A-H6-186466

With the lens unit disclosed in Patent Document 1, the amount of compensation depends on the length of the compensating block in the optical axis direction, and thus when a large amount of compensation is needed, a large space is needed in the optical axis direction. In practice, however, only a limited space in the lens unit is available for arrangement of the compensating block, restricting the amount of compensation. On the other hand, with the lens unit disclosed in Patent Document 2, compensating for a displacement in focal position occurring in the lens system requires a body lens barrel that has a different linear expansion coefficient and that is long in the optical axis direction. Thus, the design of the entire lens unit is subject to tight restrictions on flexibility in spatial arrangement. Accordingly, adopting the designs for temperature compensation disclosed in Patent Documents 1 and 2 complicates the design of lens units and makes them large in the optical axis direction.

### SUMMARY OF THE INVENTION

The present invention has been made against the background noted above, and aims to provide a lens unit that can compensate for a large displacement in focal position resulting from a variation in ambient temperature with a simple, compact design.

According to the invention, a lens unit is provided with: a lens system including a plurality of lens elements, the lens system including a compensator lens which, by moving in an optical axis direction, compensates for a displacement in focal position resulting from a variation in temperature; and a focus correction mechanism for moving the compensator lens in the optical axis direction, the focus correction mechanism including a high-expansion compensating member formed of a high-expansion material and a low-expansion compensating member formed of a low-expansion material with a lower linear expansion coefficient than the high-expansion material, the high-expansion compensating member and the low-expansion compensating member respectively having contact surfaces that make contact with each other in a state inclined with respect to the optical axis, the focus correction mechanism being designed such that, when a variation in temperature causes the high-expansion compensating member to expand or contract in a direction perpendicular to the optical axis, the low-expansion compensating member is displaced in the optical axis direction and consequently the compensator lens moves in the optical axis direction.

### BRIEF DESCRIPTION OF THE DRAWINGS

FIG. 1 is a sectional view showing a lens unit according to a first embodiment of the invention;

FIG. 2 is an enlarged sectional view showing a principal part of FIG. 1;

FIGS. 3A and 3B are sectional views showing how a focus correction mechanism operates in response to a variation in ambient temperature in the first embodiment;

FIG. 4 is a sectional view showing a lens unit according to a second embodiment of the invention;

FIG. 5 is an enlarged sectional view showing a principal part of FIG. 4;

FIGS. 6A and 6B are sectional views showing how a focus correction mechanism operates in response to a variation in ambient temperature in the second embodiment;

FIG. 7 is a sectional view showing a lens unit according to a third embodiment of the invention;

FIG. 8 is an enlarged sectional view showing a principal part of FIG. 7;

FIGS. 9A and 9B are sectional views showing how a focus correction mechanism operates in response to a variation in ambient temperature in the third embodiment; and

FIG. 10 is a plan view showing a heat-deformable ring in the third embodiment.

### DETAILED DESCRIPTION OF PREFERRED EMBODIMENTS

Hereinafter, lens units with a temperature compensation function according to the present invention will be described with reference to the accompanying drawings. Among different embodiments etc., the same or equivalent parts are identified by the same reference signs and no overlapping description will be repeated unless necessary.

A lens unit with a temperature compensation function according to the invention has a lens system composed of a plurality of lens elements, and a displacement in focal position (a so-called focus error) occurring in the lens system due to a variation in temperature is compensated for by moving, as a compensator lens, at least one lens element in the lens system in the optical axis direction. Although the embodiments described below deal with cases where the lens system incorporated in the lens unit is an image-taking lens (for example, an interchangeable lens for a camera), similar temperature compensation functions may be implemented also in cases where a projection lens (for example, an interchangeable lens for a cinematographic projector) is incorporated as a lens system.

### First Embodiment

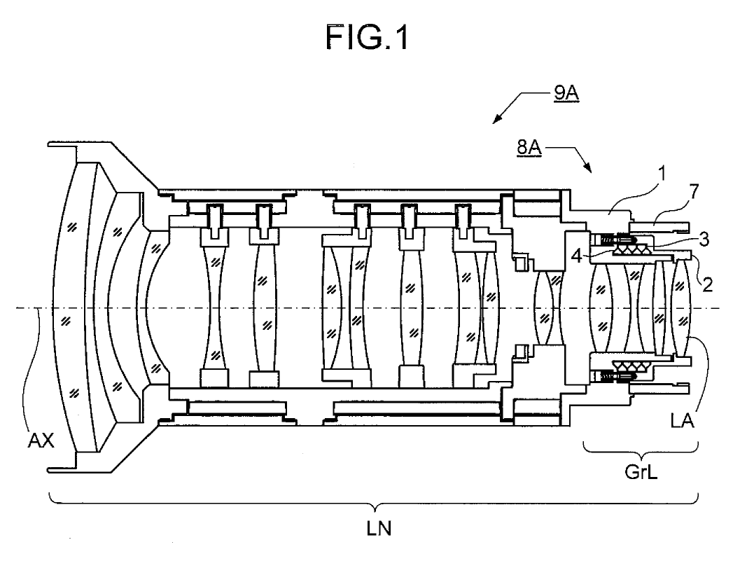

### FIGS. 1 to 3

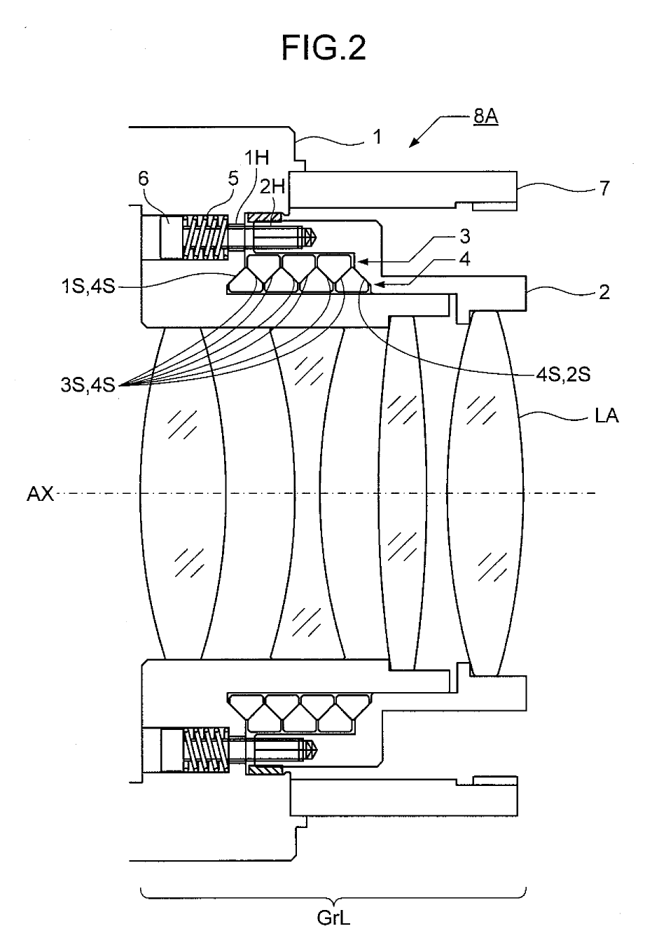

FIGS. 1 and 2 show a lens unit 9A with a temperature compensation function and a focus correction mechanism 8A according to a first embodiment of the invention. FIG. 1 schematically shows the sectional structure of the lens unit 9A, which incorporates an image-taking lens LN as a lens system. FIG. 2 shows, on an enlarged scale, a part of the lens unit 9A where it has the focus correction mechanism 8A.

The lens unit 9A shown in FIG. 1 includes, among others, the image-taking lens LN and the focus correction mechanism 8A. The image-taking lens LN is a zoom lens composed of a plurality of lens groups as movable or stationary groups, and includes a plurality of lens elements formed of anomalous dispersion glass. In the image-taking lens LN, the four most image-side lens elements (FIG. 2) constitute a last group GrL, which is stationary for zooming, with the most image-side one lens element, which is a convex lens element, serving as a compensator lens LA. As the compensator lens LA, which has a positive optical power, moves in the optical axis AX direction, the focal position of the image-taking lens LN moves. Thus, a displacement in focal position occurring in the image-taking lens LN due to a variation in temperature can be compensated for by moving the compensator lens LA in the optical axis AX direction.

As shown in FIG. 2, the focus correction mechanism 8A is composed of a stationary barrel 1, a compensator lens holding frame 2, high-expansion compensating members 3, low-expansion compensating members 4, coil springs 5, screws 6, etc. On the image side of the stationary barrel 1, a mount 7 is provided. Via this mount 7, the lens unit 9A is attached to a camera body (not shown). A principal part of the focus correction mechanism 8A is arranged inside the mount 7. Of the last group GrL, the three object-side lens elements are held on the stationary barrel 1, and the most image-side lens element, namely the compensator lens LA, is held on the compensator lens holding frame 2.

The compensator lens holding frame 2 is coupled to the stationary barrel 1 via the high-expansion compensating members 3 and the low-expansion compensating members 4, and is supported so as to be movable in the optical axis AX direction while keeping contact with the low-expansion compensating members 4. The reference for the movement of the compensator lens holding frame 2 and the compensator lens LA is the stationary barrel 1, and on the stationary barrel 1, the compensator lens holding frame 2 is supported while being biased toward it by the coil springs 5. As a biasing member, the coil springs 5 are arranged inside the stationary barrel 1, at six equally spaced positions around its circumference. Each coil spring 5 is, at the center, penetrated by a screw 6, which is put through a hole 1H in the stationary barrel 1 and is screw-engaged with a threaded hole 2H in the compensator lens holding frame 2. Tightening the screws 6 via the coil springs 5 keeps the low-expansion compensating member 4 and the high-expansion compensating member 3 biased toward the stationary barrel 1 in the optical axis AX direction.

The high-expansion compensating members 3 are formed of a high-expansion material, and the low-expansion compensating members 4 are fanned of a low-expansion material (a material with a lower linear expansion coefficient than the high-expansion material). The high-expansion compensating members 3 and the low-expansion compensating members 4 are shaped like concentric rings with respect to the optical axis AX, each having, around its circumference, two contact surfaces 3S or 4S that make contact with the corresponding surfaces around another in a state inclined with respect to the optical axis AX (with an inclination angle of 45°). The contact surfaces 3S and 4S give the high-expansion compensating members 3 and the low-expansion compensating members 4 a mountain-like shape in their section on the optical axis. Three of the high-expansion compensating members 3 (outer rings) are provided, and fourth of the low-expansion compensating members 4 (inner rings) are provided. Thus, the high-expansion compensating members 3 and the low-expansion compensating members 4 make contact with each other at a total of six contact surfaces 3S and 4S. The most object-side low-expansion compensating member 4 and the stationary barrel 1 each have, around their circumference, one contact surface 4S or 1S that makes contact with the corresponding surface around the other in a state inclined with respect to the optical axis AX (with an inclination angle of 45°). The most image-side low-expansion compensating member 4 and the compensator lens holding frame 2 each have, around their circumference, one contact surface 45 or 2S that makes contact with the corresponding surface around the other in a state inclined with respect to the optical axis AX (with an inclination angle of 45°). The inclination angle of the contact surfaces 1S, 2S, 3S, and 4S is not limited to 45°; considering the friction between the contact surfaces and the amount of displacement in the optical axis AX direction, however, it is preferable that the inclination angle be in the range of 30° to 60°.

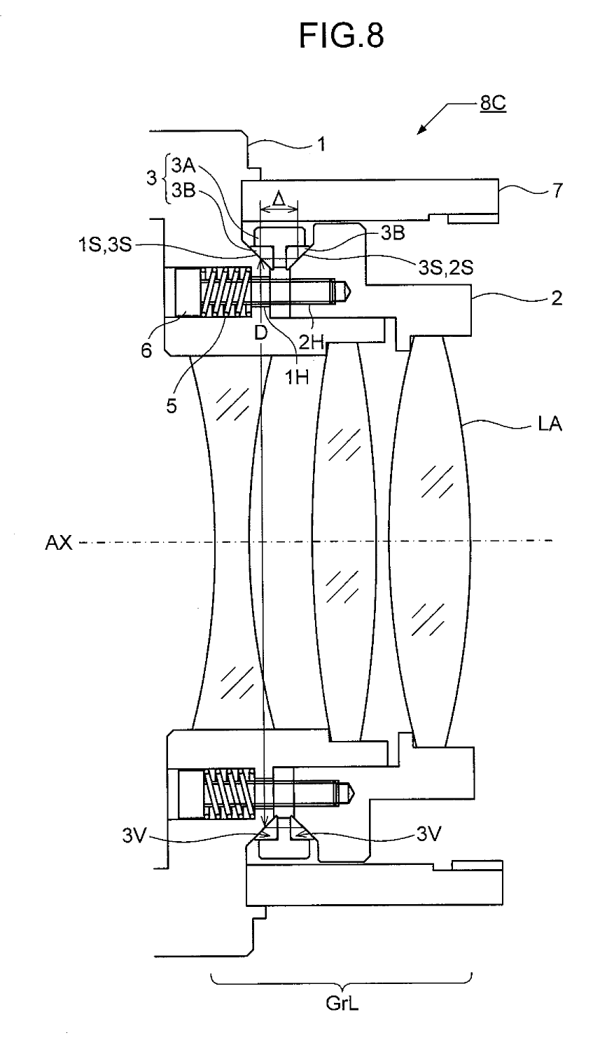

For example, the high-expansion material for the high-expansion compensating members 3 is a resin, such as POM (polyacetal resin), the low-expansion material for the low-expansion compensating members 4 is a metal, such as type 430 stainless steel, and the material for the stationary barrel 1 and the compensator lens holding frame 2 is a metal, such as aluminum. These materials have the following linear expansion coefficients: POM, 120×10⁻⁶/° C. (as stated in a data sheet of Delrin (a registered trademark) manufactured by DuPont); aluminum, 24.3×10⁻⁶/° C.; and type 430 stainless steel, 10.4×10⁻⁶/° C. Thus, the high-expansion compensating members 3 are formed of a material with a high linear expansion coefficient. It is preferable that stainless steel be surface-treated with electroless nickel combined with fluorocarbon resin to give it improved wear-resistant, sliding, and non-viscous properties. Here, it is assumed that the ratio of the center-to-center diameter D of the contact surfaces 3S and 4S of the high-expansion compensating members 3 and the low-expansion compensating members 4 to the thickness Δ in the optical axis AX direction is 16:1 (see FIG. 8, which will be discussed later) with a view to achieving sufficient expansion and contraction in the radial direction as compared with in the optical axis AX direction.

The contact surfaces 3S and 45 of the high-expansion compensating members 3 and the low-expansion compensating members 4 make contact with each other in a state inclined with respect to the optical axis AX; thus, when a variation in temperature causes the high-expansion compensating members 3 to expand or contract in the direction perpendicular to the optical axis AX, the low-expansion compensating members 4 are displaced in the optical axis AX direction. As the low-expansion compensating members 4 are displaced in the optical axis AX direction, the compensator lens holding frame 2 in contact with the low-expansion compensating member 4 and the compensator lens LA held on compensator lens holding frame 2 move in the optical axis AX direction, and thus a displacement in focal position occurring in the image-taking lens LN due to a variation in temperature can be compensated for.

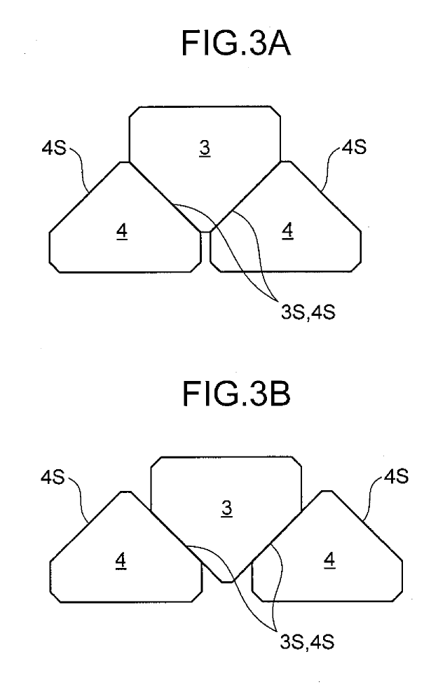

For example, suppose that the high-expansion compensating members 3 are formed of POM, that the low-expansion compensating members 4 are formed of type 430 stainless steel, and that the stationary barrel 1 and the compensator lens holding frame 2 are formed of aluminum. When the ambient temperature rises, the high-expansion compensating members 3 expand mainly in the radial direction, and the differences in linear expansion coefficient between POM and type 430 stainless steel and between aluminum and type 430 stainless steel produce a gap in the radial direction. Since the high-expansion compensating members 3, the low-expansion compensating members 4, and the compensator lens holding frame 2 are biased toward the stationary barrel 1 in the optical axis AX direction, the gap produced in the radial direction by the expansion is closed by the compensator lens holding frame 2 and the compensator lens LA held on it moving toward the object side (toward the stationary barrel 1); that is, these move away from the image surface along the optical axis AX. Δt this time, the high-expansion compensating members 3 and the low-expansion compensating members 4 are in a positional relationship as shown in FIG. 3A. When the ambient temperature falls, quite the opposite happens: the high-expansion compensating members 3 contract mainly in the radial direction, and thus the compensator lens holding frame 2 and the compensator lens LA held on it move toward the image side; that is, these move closer to the image surface along the optical axis AX. Δt this time, the high-expansion compensating members 3 and the low-expansion compensating members 4 are in a positional relationship as shown in FIG. 3B.

In the image-taking lens LN, as described previously, as the ambient temperature varies, the refractive indices of lens materials vary, and accordingly the focal position moves. Here, it is assumed that the amount by which the compensator lens LA needs to be moved (with a movement toward the image side defined as positive) to cancel the displacement in focal position is −12.5 μm/° C. Increasing the optical power of the compensator lens LA augments the effect of correcting the focal position, and thus makes it possible to correct the focal position for a given variation in temperature with a smaller amount of movement; inconveniently, doing so simultaneously increases the sensitivity of optical performance to errors, making it likely that eccentricity of the compensator lens LA accompanying its movement rather degrades imaging performance.

The amount by which the compensator lens LA moves in response to a variation in temperature is given by formulae (F1) and (F2) below.

Δl/Δt=R·(α1−α2)/tan θ (F1)

ΔL/Δt=Σ[k=1,n]aₖ (F2)

where
Δl/Δt represents the amount of displacement in the optical axis direction per contact surface per degree Celsius;
ΔL/Δt represents the total amount of displacement in the optical axis direction per degree Celsius;

a=R·(α1−α2)/tan θ;
R represents the distance from the optical axis to the contact surfaces;
θ represents the inclination angle of the contact surfaces with respect to the optical axis;
α1 represents the linear expansion coefficient on the high-expansion side of the contact at the contact surface;
α2 represents the linear expansion coefficient on the low-expansion side of the contact at the contact surface; and
n represents the number of contact surfaces.

In the first embodiment, the amount by which the compensator lens LA moves in response to a variation in temperature is calculated as ΔL/Δt=6×19 (mm)×(120×10⁻⁶−10.4×10⁻⁶)/tan 45°±2×19 (mm)×(24.3×10⁻⁶−10.4×10⁻⁶)/tan 45=0.013 mm/° C. With a movement toward the image surface defined as positive, the amount of movement is −13 μm/° C. This is largely satisfactory as compared with the necessary amount of movement −12.5 μm/° C., and it is thus possible to prevent a degradation in imaging performance due to a variation in temperature.

In the focus correction mechanism 8A of the lens unit 9A, as described above, the high-expansion compensating members 3 and the low-expansion compensating members 4 respectively have the contact surfaces 3S and 4S that make contact with each other in a state inclined with respect to the optical axis AX such that, when a variation in temperature causes the high-expansion compensating members 3 to expand or contract in the direction perpendicular to the optical axis AX, the low-expansion compensating members 4 are displaced in the optical axis AX direction. Thus, an expansion or contraction in the direction perpendicular to the optical axis AX is converted into a displacement in the optical axis AX direction by the contact surfaces 3S and 4S, and this makes it possible to obtain a large displacement in the optical axis AX direction without the need for a large space in the optical axis AX direction. The large displacement permits the compensator lens LA to move in the optical axis AX direction, and thus a large displacement in focal position resulting from a variation in ambient temperature can be compensated for with high accuracy with a simple, compact design.

In the focus correction mechanism 8A of the lens unit 9A, the compensator lens LA is held by the compensator lens holding frame 2 that is held so as to be movable in the optical axis AX direction while keeping contact with the low-expansion compensating members 4. This helps increase flexibility in the amount of displacement of the low-expansion compensating members 4 and increase the set range of the amount of movement of the compensator lens LA. Moreover, providing a plurality of high-expansion compensating members 3 and a plurality of low-expansion compensating members 4 and thereby providing a plurality of contact surfaces 3S and 4S helps effectively increase flexibility in the amount of displacement of the low-expansion compensating members 4 and increase the movement stroke of the compensator lens LA.

In the focus correction mechanism 8A of the lens unit 9A, the coil springs 5 are used to bias the low-expansion compensating members 4 toward the high-expansion compensating members 3 in the optical axis AX direction, and this helps effectively prevent a position error during use. Thus, a displacement in focal position can be compensated for with high accuracy and stability. Moreover, the high-expansion compensating members 3 and the low-expansion compensating members 4 are shaped like concentric rings with respect to the optical axis AX, and this helps simplify the design of the lens unit 9A and makes it possible to compensate for a displacement in focal position with high accuracy and stability.

### Second Embodiment

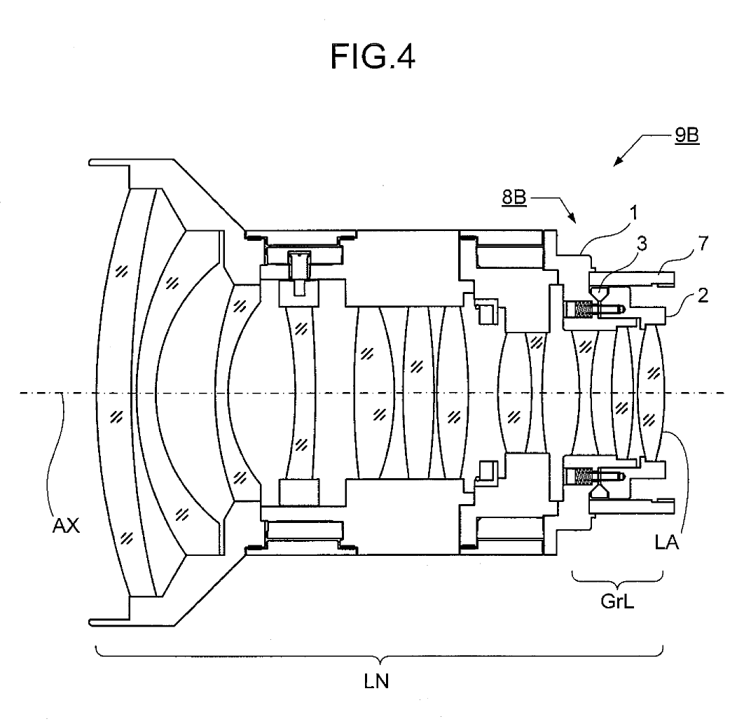

### FIGS. 4 to 6

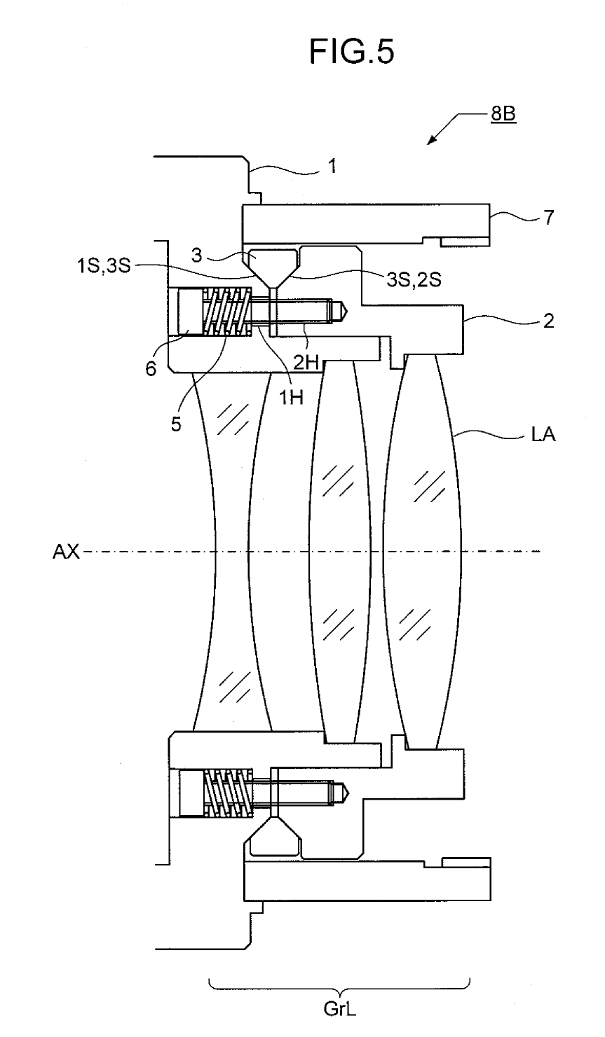

FIGS. 4 and 5 show a lens unit 9B with a temperature compensation function and a focus correction mechanism 8B according to a second embodiment of the invention. FIG. 4 schematically shows the sectional structure of the lens unit 9B, which incorporates an image-taking lens LN as a lens system. FIG. 5 shows, on an enlarged scale, a part of the lens unit 9B where it has the focus correction mechanism 8B.

The lens unit 9B shown in FIG. 4 includes, among others, the image-taking lens LN and the focus correction mechanism 8B. The image-taking lens LN is a single-focus lens with a focal length of 28 mm, and is composed of lens elements formed of optical glass with ordinary dispersion. In the image-taking lens LN, the three most image-side lens elements (FIG. 5) constitute a last group GrL in the lens type, with the most image-side one lens element, which is a convex lens element, serving as the compensator lens LA. As the compensator lens LA, which has a positive optical power, moves in the optical axis AX direction, the focal position of the image-taking lens LN moves. Thus, a displacement in focal position occurring in the image-taking lens LN due to a variation in temperature can be compensated for by moving the compensator lens LA in the optical axis AX direction.

As shown in FIG. 5, the focus correction mechanism 8B is composed of a stationary barrel 1, a compensator lens holding frame 2, a high-expansion compensating member 3, coil springs 5, screws 6, etc. On the image side of the stationary barrel 1, a mount 7 is provided. Via this mount 7, the lens unit 9B is attached to a camera body (not shown). A principal part of the focus correction mechanism 8B is arranged inside the mount 7. Of the last group GrL, the two object-side lens elements are held on the stationary barrel 1, and the most image-side lens element, namely the compensator lens LA, is held on the compensator lens holding frame 2.

The compensator lens holding frame 2 is coupled to the stationary barrel 1 via the high-expansion compensating member 3, and is supported so as to be movable in the optical axis AX direction while keeping contact with the high-expansion compensating member 3. The reference for the movement of the compensator lens holding frame 2 and the compensator lens LA is the stationary barrel 1, and on the stationary barrel 1, the compensator lens holding frame 2 is supported while being biased toward it by the coil springs 5. As a biasing member, the coil springs 5 are arranged inside the stationary barrel 1, at six equally spaced positions around its circumference. Each coil spring 5 is, at the center, penetrated by a screw 6, which is put through a hole 1H in the stationary barrel 1 and is screw-engaged with a threaded hole 2H in the compensator lens holding frame 2. Tightening the screws 6 via the coil springs 5 keeps the high-expansion compensating member 3 biased toward the stationary barrel 1 in the optical axis AX direction.

The high-expansion compensating member 3 is formed of a high-expansion material, and the compensator lens holding frame 2 is formed of a low-expansion material (a material with a lower linear expansion coefficient than the high-expansion material). The high-expansion compensating member 3 is shaped like a concentric ring with respect to the optical axis AX, and has, around its circumference, two contact surfaces 3S that are inclined with respect to the optical axis AX (with an inclination angle of 45°). The stationary barrel 1 has, around its circumference, one contact surface 1S that is inclined with respect to the optical axis AX (with an inclination angle of 45°), and the compensator lens holding frame 2 has, around its circumference, one contact surface 2S that is inclined with respect to the optical axis AX (with an inclination angle of 45°). One contact surface 3S of the high-expansion compensating member 3 and the contact surface 1S of the stationary barrel 1 make contact with each other, and the other contact surface 3S of the high-expansion compensating member 3 and the contact surface 2S of the compensator lens holding frame 2 make contact with each other. The inclination angle of the contact surfaces 1S, 2S, and 3S is not limited to 4S′; considering the friction between the contact surfaces and the amount of displacement in the optical axis AX direction, however, it is preferable that the inclination angle be in the range of 30° to 60°.

For example, the high-expansion material for the high-expansion compensating member 3 is a resin, such as POM (polyacetal resin), and the material for the stationary barrel 1 and the compensator lens holding frame 2 is a metal, such as aluminum. These materials have the following linear expansion coefficients: POM, 120×10⁻⁶/° C. (as stated in a data sheet of Delrin (a registered trademark) manufactured by DuPont); and aluminum, 24.3×10⁻⁶/° C. Thus, the high-expansion compensating member 3 (POM ring) with a higher linear expansion coefficient is arranged outside the contact surfaces 1S and 2S. Here, it is assumed that the ratio of the center-to-center diameter D of the contact surfaces 3S and 2S of the high-expansion compensating member 3 and the compensator lens holding frame 2 to the thickness Δ in the optical axis AX direction is 15:1 (see FIG. 8, which will be discussed later) with a view to achieving sufficient expansion and contraction in the radial direction as compared with in the optical axis AX direction.

The contact surfaces 3S and 2S of the high-expansion compensating member 3 and the compensator lens holding frame 2 make contact with each other in a state inclined with respect to the optical axis AX; thus, when a variation in temperature causes the high-expansion compensating member 3 to expand or contract in the direction perpendicular to the optical axis AX, the compensator lens holding frame 2 is displaced in the optical axis AX direction. Consequently, the compensator lens holding frame 2 and the compensator lens LA held on compensator lens holding frame 2 move in the optical axis AX direction, and thus a displacement in focal position occurring in the image-taking lens LN due to a variation in temperature can be compensated for.

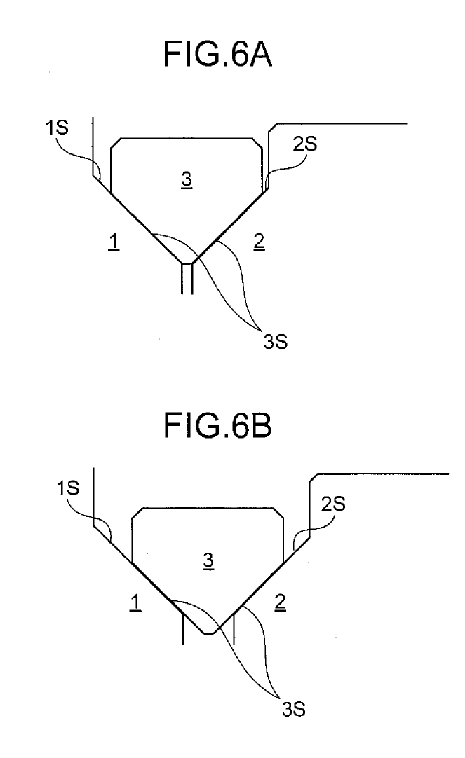

For example, suppose that the high-expansion compensating member 3 is formed of POM, and that the stationary barrel 1 and the compensator lens holding frame 2 are formed of aluminum. When the ambient temperature rises, the high-expansion compensating member 3 expands mainly in the radial direction, and the difference in linear expansion coefficient between POM and aluminum produces a gap in the radial direction. Since the high-expansion compensating member 3 and the compensator lens holding frame 2 are biased toward the stationary barrel 1 in the optical axis AX direction, the gap produced in the radial direction by the expansion is closed by the compensator lens holding frame 2 and the compensator lens LA held on it moving toward the object side (toward the stationary barrel 1); that is, these move away from the image surface along the optical axis AX. At this time, the stationary barrel 1, the high-expansion compensating member 3, and compensator lens holding frame 2 are in a positional relationship as shown in FIG. 6A. When the ambient temperature falls, quite the opposite happens: the high-expansion compensating member 3 contracts mainly in the radial direction, and thus the compensator lens holding frame 2 and the compensator lens LA held on it move toward the image side; that is, these move closer to the image surface along the optical axis AX. Δt this time, the stationary barrel 1, the high-expansion compensating member 3, and the compensator lens holding frame 2 are in a positional relationship as shown in FIG. 6B.

In the image-taking lens LN, as described previously, as the ambient temperature varies, the refractive indices of lens materials vary, and accordingly the focal position moves. The amount of displacement is about one-fourth of that in the image-taking lens LN (FIG. 1) including anomalous dispersion glass according to the first embodiment, and accordingly the amount by which the compensator lens LA needs to be moved (with a movement toward the image side defined as positive) to cancel the displacement in focal position is comparatively small, namely −3.4 μm/° C. In comparison, in the second embodiment, the amount by which the compensator lens LA moves due to a variation in temperature is ΔL/Δt=2×19 (mm)×(120×10⁻⁶⁻24.3×10⁻⁶)/tan 45°=0.0036 mm/° C. With a movement toward the image surface defined as positive, the amount of movement is −3.6 μm/° C. This is largely satisfactory as compared with the necessary amount of movement −3.4 μm/° C., and it is thus possible to prevent a degradation in imaging performance due to a variation in temperature.

In the focus correction mechanism 8B of the lens unit 9B, as described above, the high-expansion compensating member 3 and the compensator lens holding frame 2 respectively have the contact surfaces 3S and 2S that make contact with each other in a state inclined with respect to the optical axis AX such that, when a variation in temperature causes the high-expansion compensating member 3 to expand or contract in the direction perpendicular to the optical axis AX, the compensator lens holding frame 2 is displaced in the optical axis AX direction. Thus, an expansion or contraction in the direction perpendicular to the optical axis AX is converted into a displacement in the optical axis AX direction by the contact surfaces 3S and 2S, and this makes it possible to obtain a large displacement in the optical axis AX direction without the need for a large space in the optical axis AX direction. The large displacement permits the compensator lens LA to move in the optical axis AX direction, and thus a large displacement in focal position resulting from a variation in ambient temperature can be compensated for with high accuracy with a simple, compact design.

In the focus correction mechanism 8B of the lens unit 9B, the compensator lens holding frame 2 is used as a low-expansion compensating member, and this helps increase the amount of movement of the compensator lens LA with a simple design, and also helps obtain a centering effect of suppressing the inclination of the compensator lens holding frame 2 accompanying its movement. Thus, it is possible to compensate for a displacement in focal position with high accuracy and stability.

In the focus correction mechanism 8B of the lens unit 9B, the coil springs 5 are used to bias the compensator lens holding frame 2 toward the high-expansion compensating member 3 in the optical axis AX direction, and this helps effectively prevent a position error during use. Thus, a displacement in focal position can be compensated for with high accuracy and stability. Moreover, the high-expansion compensating member 3 is shaped like a concentric ring with respect to the optical axis AX, and this helps simplify the design of the lens unit 9B and makes it possible to compensate for a displacement in focal position with high accuracy and stability.

### Third Embodiment

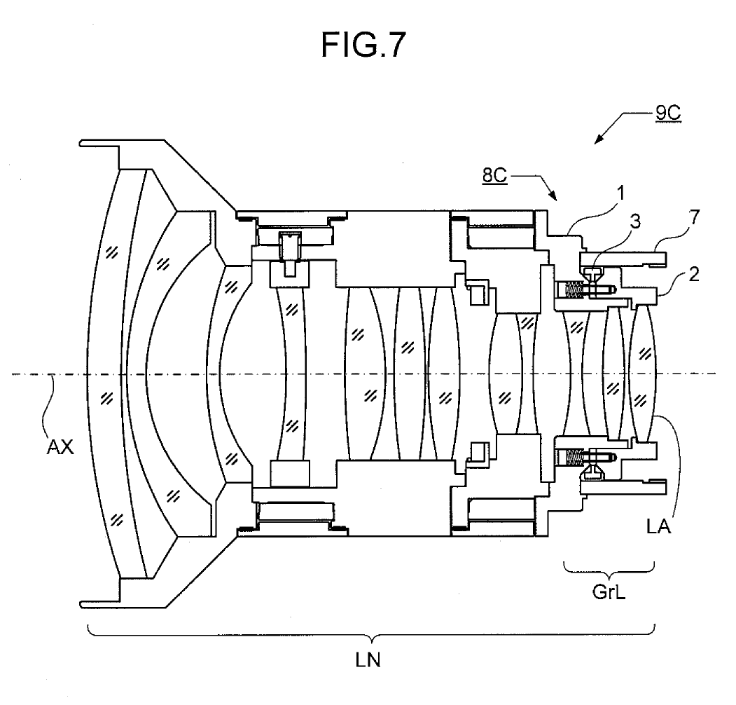

### FIGS. 7 to 10

FIGS. 7 and 8 show a lens unit 9C with a temperature compensation function and a focus correction mechanism 8C according to a third embodiment of the invention. FIG. 7 schematically shows the sectional structure of the lens unit 9C, which incorporates an image-taking lens LN as a lens system. FIG. 8 shows, on an enlarged scale, a part of the lens unit 9C where it has the focus correction mechanism 8C.

The lens unit 9C shown in FIG. 7 includes, among others, the image-taking lens LN and the focus correction mechanism 8C. The image-taking lens LN is a single-focus lens with a focal length of 28 mm, and is composed of lens elements formed of optical glass with ordinary dispersion. In the image-taking lens LN, the three most image-side lens elements (FIG. 8) constitute a last group GrL in the lens type, with the most image-side one lens element, which is a convex lens element, serving as the compensator lens LA. As the compensator lens LA, which has a positive optical power, moves in the optical axis AX direction, the focal position of the image-taking lens LN moves. Thus, a displacement in focal position occurring in the image-taking lens LN due to a variation in temperature can be compensated for by moving the compensator lens LA in the optical axis AX direction.

As shown in FIG. 8, the focus correction mechanism 8C is composed of a stationary barrel 1, a compensator lens holding frame 2, a high-expansion compensating member 3, coil springs 5, screws 6, etc. On the image side of the stationary barrel 1, a mount 7 is provided. Via this mount 7, the lens unit 9C is attached to a camera body (not shown). A principal part of the focus correction mechanism 8C is arranged inside the mount 7. Of the last group GrL, the two object-side lens elements are held on the stationary barrel 1, and the most image-side lens element, namely the compensator lens LA, is held on the compensator lens holding frame 2.

The compensator lens holding frame 2 is coupled to the stationary barrel 1 via the high-expansion compensating member 3, and is supported so as to be movable in the optical axis AX direction while keeping contact with the high-expansion compensating member 3. The reference for the movement of the compensator lens holding frame 2 and the compensator lens LA is the stationary barrel 1, and on the stationary barrel 1, the compensator lens holding frame 2 is supported while being biased toward it by the coil springs 5. As a biasing member, the coil springs 5 are arranged inside the stationary barrel 1, at six equally spaced positions around its circumference. Each coil spring 5 is, at the center, penetrated by a screw 6, which is put through a hole 1H in the stationary barrel 1 and is screw-engaged with a threaded hole 2H in the compensator lens holding frame 2. Tightening the screws 6 via the coil springs 5 keeps the high-expansion compensating member 3 biased toward the stationary barrel 1 in the optical axis AX direction.

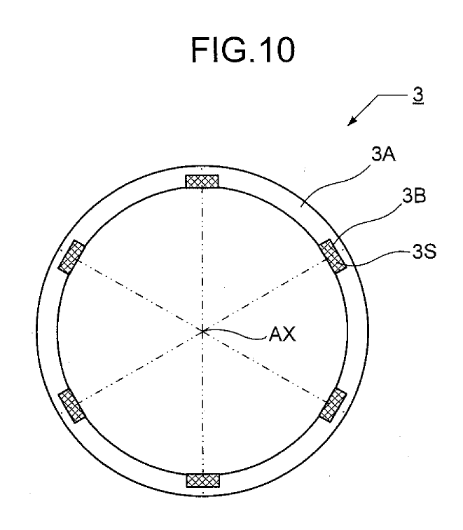

The high-expansion compensating member 3 is composed of a compensating main element 3A and sliding elements 3B. The compensating main element 3A is formed of a high-expansion material, and the sliding elements 3B and the compensator lens holding frame 2 are formed of a low-expansion material (a material with a lower linear expansion coefficient than the high-expansion material). The compensating main element 3A is shaped like a concentric ring with respect to the optical axis AX, and has cut grooves 3V formed in its inner circumference, on each of the front and back sides of the ring, one at each of six equally spaced positions around the circumference. As shown in FIG. 10, in the cut grooves 3V formed in the compensating main element 3A, the sliding elements 3B, which are shaped like chips, are fixed by bonding. The sliding elements 3B are formed of the same material as the compensator lens holding frame 2, and have contact surfaces 3S that are inclined with respect to the optical axis AX (with an inclination angle of 45°). It is preferable that the sliding elements 3B be subject to Tufram (a registered trademark) surface treatment to give them improved wear-resistant, sliding, and incision-resistant properties.

The stationary barrel 1 (FIG. 8) has, around its circumference, one contact surface 1S that is inclined with respect to the optical axis AX (with an inclination angle of 45°), and the compensator lens holding frame 2 has, around its circumference, one contact surface 2S that is inclined with respect to the optical axis AX (with an inclination angle of 45°). One contact surface 3S of the sliding elements 3B and the contact surface 1S of the stationary barrel 1 make contact with each other, and the other contact surface 3S of the sliding elements 3B and the contact surface 2S of the compensator lens holding frame 2 make contact with each other. The inclination angle of the contact surfaces 1S, 2S, and 3S is not limited to 45°; considering the friction between the contact surfaces and the amount of displacement in the optical axis AX direction, however, it is preferable that the inclination angle be in the range of 30° to 60°.

For example, the high-expansion material for the compensating main element 3A is a resin, such as POM (polyacetal resin), and the material for the sliding elements 3B, the stationary barrel 1, and the compensator lens holding frame 2 is a metal, such as aluminum. These materials have the following linear expansion coefficients: POM, 120×10⁻⁶/° C. (as stated in a data sheet of Delrin (a registered trademark) manufactured by DuPont); and aluminum, 24.3×10⁻⁶/° C. Thus, the high-expansion compensating member 3 (POM ring) with a higher linear expansion coefficient is arranged outside the contact surfaces 1S and 2S. Here, it is assumed that the ratio of the center-to-center diameter D of the contact surfaces 3S and 2S of the high-expansion compensating member 3 and the compensator lens holding frame 2 to the thickness Δ in the optical axis AX direction is 15:1 with a view to achieving sufficient expansion and contraction in the radial direction as compared with in the optical axis AX direction.

The contact surfaces 3S and 2S of the high-expansion compensating member 3 and the compensator lens holding frame 2 make contact with each other in a state inclined with respect to the optical axis AX; thus, when a variation in temperature causes the compensating main element 3A of the high-expansion compensating member 3 to expand or contract in the direction perpendicular to the optical axis AX, the compensator lens holding frame 2 is displaced in the optical axis AX direction. Consequently, the compensator lens holding frame 2 and the compensator lens LA held on compensator lens holding frame 2 move in the optical axis AX direction, and thus a displacement in focal position occurring in the image-taking lens LN due to a variation in temperature can be compensated for.

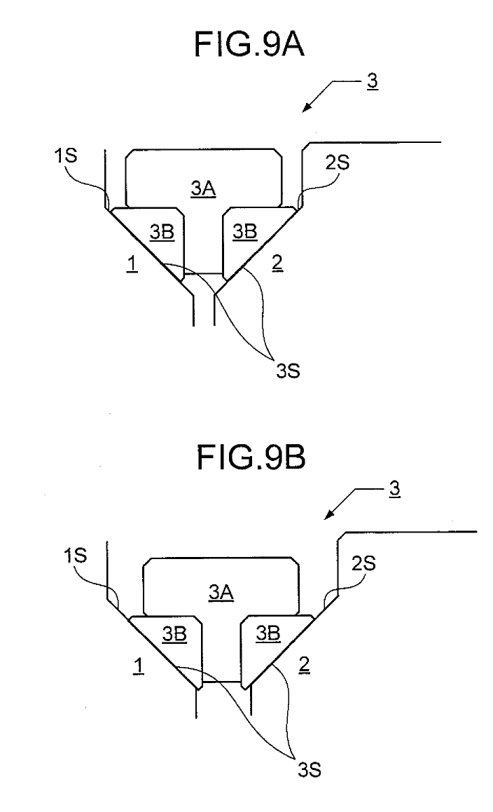

For example, suppose that the compensating main element 3A is formed of POM, and that the sliding elements 3B, the stationary barrel 1, and the compensator lens holding frame 2 are formed of aluminum. When the ambient temperature rises, the compensating main element 3A expands mainly in the radial direction, and the difference in linear expansion coefficient between POM and aluminum produces a gap in the radial direction between, on one hand, the sliding elements 3B and, on the other hand, the stationary barrel 1 and the compensator lens holding frame 2. Since the high-expansion compensating member 3 and the compensator lens holding frame 2 are biased toward the stationary barrel 1 in the optical axis AX direction, the gap produced in the radial direction by the expansion is closed by the compensator lens holding frame 2 and the compensator lens LA held on it moving toward the object side (toward the stationary barrel 1); that is, these move away from the image surface along the optical axis AX. At this time, the stationary barrel 1, the high-expansion compensating member 3, and compensator lens holding frame 2 are in a positional relationship as shown in FIG. 9A. When the ambient temperature falls, quite the opposite happens: the compensating main element 3A contracts mainly in the radial direction, and thus the compensator lens holding frame 2 and the compensator lens LA held on it move toward the image side; that is, these move closer to the image surface along the optical axis AX. At this time, the stationary barrel 1, the high-expansion compensating member 3, and the compensator lens holding frame 2 are in a positional relationship as shown in FIG. 9B.

Since the contact surfaces 1S, 2S, and 3S are all formed of the same material, the amounts by which the angles of the contact surfaces 15, 2S, and 3S with respect to the optical axis AX vary as a result of the expansion or contraction of the material due to a variation in temperature are all equal. A resin and a metal differ greatly in linear expansion coefficient; thus, an extremely large variation in temperature may produce so large a difference in contact angle among the contact surfaces 1S, 2S, and 3S as to result in poor sliding properties. This can be prevented by using the same material. Even when different materials are used, so long as they are all metals, it is possible to suppress the effect of poor sliding properties resulting from a difference in linear expansion coefficient.

In the image-taking lens LN, as described previously, as the ambient temperature varies, the refractive indices of lens materials vary, and accordingly the focal position moves. The amount of displacement is about one-fourth of that in the image-taking lens LN (FIG. 1) including anomalous dispersion glass according to the first embodiment, and accordingly the amount by which the compensator lens LA needs to be moved (with a movement toward the image side defined as positive) to cancel the displacement in focal position is comparatively small, namely −3.4 μm/° C. In comparison, in the third embodiment, the amount by which the compensator lens LA moves due to a variation in temperature is ΔL/Δt=2×19 (mm)×(120×10⁻⁶−24.3×10⁻⁶)/tan 45°=0.0036 mm/° C. With a movement toward the image surface defined as positive, the amount of movement is −3.6 μm/° C. This is largely satisfactory as compared with the necessary amount of movement −3.4 μm/° C., and it is thus possible to prevent a degradation in imaging performance due to a variation in temperature.

In the focus correction mechanism 8C of the lens unit 9C, as described above, the high-expansion compensating member 3 and the compensator lens holding frame 2 respectively have the contact surfaces 3S and 2S that make contact with each other in a state inclined with respect to the optical axis AX such that, when a variation in temperature causes the high-expansion compensating member 3 to expand or contract in the direction perpendicular to the optical axis AX, the compensator lens holding frame 2 is displaced in the optical axis AX direction. Thus, an expansion or contraction in the direction perpendicular to the optical axis AX is converted into a displacement in the optical axis AX direction by the contact surfaces 3S and 2S, and this makes it possible to obtain a large displacement in the optical axis AX direction without the need for a large space in the optical axis AX direction. The large displacement permits the compensator lens LA to move in the optical axis AX direction, and thus a large displacement in focal position resulting from a variation in ambient temperature can be compensated for with high accuracy with a simple, compact design.

In the focus correction mechanism 8C of the lens unit 9C, the compensator lens holding frame 2 is used as a low-expansion compensating member, and this helps increase the amount of movement of the compensator lens LA with a simple design, and also helps obtain a centering effect of suppressing the inclination of the compensator lens holding frame 2 accompanying its movement. Thus, it is possible to compensate for a displacement in focal position with high accuracy and stability.

In the focus correction mechanism 8C of the lens unit 9C, the coil springs 5 are used to bias the compensator lens holding frame 2 toward the high-expansion compensating member 3 in the optical axis AX direction, and this helps effectively prevent a position error during use. Thus, a displacement in focal position can be compensated for with high accuracy and stability. Moreover, the high-expansion compensating member 3 is shaped like a concentric ring with respect to the optical axis AX, and this helps simplify the design of the lens unit 9C and makes it possible to compensate for a displacement in focal position with high accuracy and stability.

In the second embodiment, a variation in ambient temperature may produce a slight difference in contact angle between the high-expansion compensating member 3 and the compensator lens holding frame 2 which make contact with each other at the contact surfaces 3S and 2S. As described above, when the high-expansion compensating member 3 is designed to have, around its circumference concentric with respect to the optical axis AX, a plurality of sliding elements 3B that are formed of the same material as the compensator lens holding frame 2 and that form the contact surface 3S, sliding occurs at the contact surfaces 3S that are formed of the same material; thus, it is possible to prevent a difference in contact angle as mentioned above while maintaining the effect of correcting a displacement in focal position. Moreover, reducing the contact area on the contact surfaces 3S helps reduce the friction during movement, and in addition using a low-friction material helps further reduce the friction directly. Thus, a displacement in focal position can be compensated for with high accuracy and stability.

In the lens units of the embodiments described above, a high-expansion compensating member and a low-expansion compensating member respectively have contact surfaces that make contact with each other in a state inclined with respect to the optical axis such that, when a variation in temperature causes the high-expansion compensating member to expand or contract in the direction perpendicular to the optical axis, the low-expansion compensating member is displaced in the optical axis direction. Thus, an expansion or contraction in the direction perpendicular to the optical axis is converted into a displacement in the optical axis direction, and this makes it possible to obtain a large displacement in the optical axis direction without the need for a large space in the optical axis direction. The large displacement permits a compensator lens to be moved in the optical axis direction, and thus a large displacement in focal position due to a variation in ambient temperature can be compensated for with high accuracy with a simple, compact design.

By holding the compensator lens with a holding member that is supported so as to be movable in the optical axis direction while keeping contact with the low-expansion compensating member, it is possible to increase flexibility in the amount of displacement of the low-expansion compensating member and increase the set range of the amount of movement of the compensator lens. For example, by providing, as at least one of the high-expansion compensating member and the low-expansion compensating member, a plurality of such compensating members and thereby forming a plurality of contact surfaces, it is possible to effectively increase flexibility in the amount of displacement of the low-expansion compensating member and increase the movement stroke of the compensator lens. Moreover, using the holding member as at least part of the low-expansion compensating member helps increase the amount of movement of the compensator lens with a simple design, and also helps obtain a centering effect of suppressing the inclination of the holding member accompanying its movement. Thus, a displacement in focal position can be compensated for with high accuracy and stability.

Using a biasing member (for example, a coil spring) to bias the low-expansion compensating member (for example, a holding member) toward the high-expansion compensating member in the optical axis direction makes it possible to effectively prevent a position error during use, and thus makes it possible to compensate for a displacement in focal position with high accuracy and stability. Moreover, forming the high-expansion compensating member and the low-expansion compensating member into concentric rings with respect to the optical axis makes it possible to simplify the design of the lens unit, and makes it possible to compensate for a displacement in focal position with high accuracy and stability.

A variation in ambient temperature may produce a slight difference in contact angle between the high-expansion compensating member and the low-expansion compensating member which make contact with each other at the contact surfaces. When the high-expansion compensating member is designed to have, around its circumference concentric with respect to the optical axis, a plurality of sliding elements that are formed of the same material as the compensator lens holding frame and that form the contact surface, sliding occurs at the contact surfaces that are formed of the same material; thus, it is possible to prevent a difference in contact angle while maintaining the effect of correcting a displacement in focal position. Moreover, reducing the contact area on the contact surfaces helps reduce the friction during movement, and in addition using a low-friction material helps further reduce the friction directly. Thus, a displacement in focal position can be compensated for with high accuracy and stability.

What is claimed is:

1. A lens unit comprising:
a lens system including a plurality of lens elements, the lens system including a compensator lens which, by moving in an optical axis direction, compensates for a displacement in focal position resulting from a variation in temperature; and
a focus correction mechanism for moving the compensator lens in the optical axis direction,
the focus correction mechanism including
a high-expansion compensating member formed of a high-expansion material and
a low-expansion compensating member formed of a low-expansion material with a lower linear expansion coefficient than the high-expansion material,
the high-expansion compensating member and the low-expansion compensating member respectively having contact surfaces that make contact with each other in a state inclined with respect to the optical axis,
the focus correction mechanism being designed such that, when a variation in temperature causes the high-expansion compensating member to expand or contract in a direction perpendicular to the optical axis, the low-expansion compensating member is displaced in the optical axis direction and consequently the compensator lens moves in the optical axis direction.

2. The lens unit according to claim 1, further comprising:
a stationary barrel serving as a reference for movement of the compensator lens; and
a holding member for holding the compensator lens, the holding member being coupled to the stationary barrel via the high-expansion compensating member and the low-expansion compensating member and supported so as to be movable in the optical axis direction while keeping contact with the low-expansion compensating member.

3. The lens unit according to claim 1, further comprising:
a stationary barrel serving as a reference for movement of the compensator lens; and
a holding member for holding the compensator lens,
wherein the low-expansion compensating member has, as at least part thereof, the holding member.

4. The lens unit according to claim 1, further comprising a biasing member for biasing the low-expansion compensating member toward the high-expansion compensating member in the optical axis direction.

5. The lens unit according to claim 1, wherein the high-expansion compensating member and the low-expansion compensating member are shaped like concentric rings with respect to the optical axis.

6. The lens unit according to claim 2, wherein the high-expansion compensating member and the low-expansion compensating member are shaped like concentric rings with respect to the optical axis.

7. The lens unit according to claim 3, wherein the high-expansion compensating member and the low-expansion compensating member are shaped like concentric rings with respect to the optical axis.

8. The lens unit according to claim 1, comprising either or both of a plurality of high-expansion compensating members as the high-expansion compensating member and a plurality of low-expansion compensating members as the low-expansion compensating member so that a plurality of contact surfaces are formed as the contact surface.

9. The lens unit according to claim 5, comprising either or both of a plurality of high-expansion compensating members as the high-expansion compensating member and a plurality of low-expansion compensating members as the low-expansion compensating member so that a plurality of contact surfaces are formed as the contact surface.

10. The lens unit according to claim 1, wherein the high-expansion compensating member has, around a circumference thereof concentric with respect to the optical axis, a plurality of sliding elements formed of a same material as the low-expansion compensating member and forming the contact surfaces.

11. The lens unit according to claim 5, wherein the high-expansion compensating member has, around a circumference thereof concentric with respect to the optical axis, a plurality of sliding elements formed of a same material as the low-expansion compensating member and forming the contact surfaces.

12. The lens unit according to claim 8, wherein the high-expansion compensating member has, around a circumference thereof concentric with respect to the optical axis, a plurality of sliding elements formed of a same material as the low-expansion compensating member and forming the contact surfaces.

13. The lens unit according to claim 1, wherein the contact surfaces are inclined at 30° to 60° with respect to the optical axis.

14. The lens unit according to claim 5, wherein the high-expansion compensating member and the low-expansion compensating member each have two contact surfaces that are inclined in mutually different directions and that have a mountain-like shape in a section thereof on the optical axis.

15. The lens unit according to claim 1, wherein the high-expansion material is a resin and the low-expansion material is a metal.

16. The lens unit according to claim 1, wherein the high-expansion material and the low-expansion material are different metals.

17. The lens unit according to claim 1, further comprising:
a stationary barrel serving as a reference for movement of the compensator lens; and
a holding member for holding the compensator lens, the holding member has, as the low-expansion compensating member, a contact surface formed of the low-expansion material and making contact with the high-expansion compensating member.

18. The lens unit according to claim 9, wherein the high-expansion compensating member and the low-expansion compensating member are arranged alternately in the optical axis direction.

19. The lens unit according to claim 18, further comprising:
a stationary barrel serving as a reference for movement of the compensator lens; and
a holding member for holding the compensator lens, the holding member being coupled to the stationary barrel via the high-expansion compensating member and the low-expansion compensating member and supported so as to be movable in the optical axis direction while keeping contact with the low-expansion compensating member.

20. The lens unit according to claim 1, wherein the low-expansion material is surface-treated for improved sliding properties.
